(19) United States
(12) Patent Application Publication
(10) Pub. No.: US 2004/0210753 A1
(43) Pub. Date: Oct. 21, 2004

(54) Groupware

(76) Inventors: Kenji Goshima, Tokyo (JP); Naoya Yamaguchi, Tokyo (JP)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/473,020

(22) PCT Filed: Mar. 26, 2001
(86) PCT No.: PCT/JP01/02397

(51) Int. Cl. G06F 17/30

(52) U.S. Cl. 713/100

(57) ABSTRACT

It is an object of the present invention to provide groupware that reduces the burden of operation upon the user. The groupware according to the present invention operates upon a stipulated OS and permits usage by various users upon login and comprises: means of changing the parameters of stipulated applications associated to said groupware depending on the username at the time of login and means of returning said parameters of said stipulated applications at the time of logoff to their state prior to said login. With the present invention, parameters of the stipulated applications are changed depending on the username at the time of login, so there is no need for the users to change various settings and the like manually themselves, thus lessening the burden of operation. In addition, these parameters are returned to their original states at the time of logoff, so they do not affect the next user.

### BACKGROUND OF THE INVENTION

The present invention relates to groupware and particularly to groupware that reduces the burden of operation upon the user.

### DESCRIPTION OF THE PRIOR ART

With the expansion of computer technology in recent years, even an elementary or intermediate school may now have a local area network (LAN) that is used for study and exchanging opinions among students and the like. Such an in-school LAN typically consists of a server connected to a plurality of client computers, so the students can operate any of the client computers to use a plurality of applications.

In such an in-school LAN, in addition to the various applications, so-called groupware is also typically used so that the usage of applications by users is permitted only by logging in to this groupware.

Here, after logging in to the groupware, students may want to save files created using the various applications, so they must select “Save File” from these applications, but in this case, a specific folder (directory) on the client computer currently in use is typically specified as the default destination to save the file. However, it is rare that a specific client computer is allocated to each student in the school, so typically the client computers are shared by a plurality of students, and thus the operation of changing the destination to save the file from the default folder on the client computer to a specified folder on the server must be performed each time that a file is saved.

However, considering that the users (students) are elementary school students and thus young in age, performing the operation of changing the save destination every time a file is saved is difficult in practice.

Moreover, the default destination of a save is typically different for each application, so if the student neglects to perform the operation of changing the save destination, the files thus created will be scattered in various folders on the client computer. Thus, it becomes very troublesome to move the files stored in folders on the client computers to folders on the server later.

In this manner, with conventional groupware, there is a problem in that the files created by users are easily scattered and not easily viewed by the instructors serving as administrators.

In addition, the operating environment of the application typically depends on its immediately previous state of usage, so when many students share client computers as in a school LAN, the operating environment of each application will be different on each client computer. For this reason, if the users (students) wish to use the applications in the operating environment they prefer, it is necessary for the environment settings to be changed immediately upon starting up the application, so this increases the burden of operation upon the users.

In this situation, groupware with a lesser burden of operation upon the users is desirable.

Accordingly, an object of the present invention is to provide groupware that reduces-the burden of operation upon the user.

### SUMMARY OF THE INVENTION

This object of the present invention is achieved by groupware that operates upon a stipulated OS and permits usage by various users upon login, comprising: means of changing the parameters of stipulated applications associated to the groupware depending on the username at the time of login and means of returning the parameters of the stipulated applications at the time of logoff to their state prior to the login.

With the present invention, parameters of the stipulated applications are changed depending on the username at the time of login, so there is no need for the users to change various settings and the like manually themselves, thus lessening the burden of operation. In addition, these parameters are returned to their original states at the time of logoff, so they do not affect the next user.

This object of the present invention is also achieved by groupware that operates upon a stipulated OS and permits usage by various users upon login, comprising: means of changing the parameters of stipulated applications associated to the groupware in response to a login with a first username and means of changing the parameters of the stipulated applications to a second content different from the first content in response to a login with a second username.

With the present invention also, parameters of the stipulated applications are changed depending on the username used at login, so there is no need for the users to change various settings and the like manually themselves, thus lessening the burden of operation.

This object of the present invention is also achieved by groupware that operates upon a stipulated OS and permits usage by various users upon login, comprising: means of saving the parameters of stipulated applications associated to the groupware at the time of a login and means of changing the parameters of the stipulated applications depending on the username after the saving is performed.

With the present invention also, parameters of the stipulated applications are changed depending on the username used at login, so there is no need for the users to change various settings and the like manually themselves, thus lessening the burden of operation. In addition, the parameters before being changed are saved, so when their content is returned to their original states, this can be performed easily.

This object of the present invention is also achieved by groupware that operates upon a stipulated OS and permits usage by various users upon login, comprising: means of getting from a server parameters corresponding to the username, means of replacing parameters of stipulated applications associated to the groupware with the parameters thus gotten, means of changing the content of the parameters thus replaced based on the operation of the user logging in, and means of saving the changed parameters on the server at the time of a logoff.

With the present invention also, parameters of the stipulated applications are changed depending on the username used at login, so there is no need for the users to change various settings and the like manually themselves, thus lessening the burden of operation. In addition, the parameters are saved on the server at the time of a logoff, so even if the content of the parameters is changed based on the operation of the user, this can be utilized at the time of the next login.

In a preferred embodiment of the present invention, the parameters define the folder specified as the default destination of saving when a file save is specified with respect to the stipulated applications.

In a preferred embodiment of the present invention, the parameter that defines the folder specified as the default destination of saving is changed depending on the username used at login, so there is no need for the user to perform the operation of changing the destination for saving files. This reduces the burden of operation upon the user and also effectively prevents the scattering of files.

### BRIEF DESCRIPTION OF THE DRAWINGS

FIG. 1 is a schematic block diagram showing a school LAN to which the groupware according to a preferred embodiment of the present invention is applied.

FIG. 2 is a flowchart used to describe the operation of the user tool 1 of the groupware according to a preferred embodiment of the present invention.

FIG. 3 is an example of a menu screen.

FIG. 4 is a flowchart used to describe the operation of user tool 1 of the groupware according to another preferred embodiment of the present invention.

### DESCRIPTION OF THE PREFERRED EMBODIMENTS

Preferred embodiments of the present invention will now be explained.

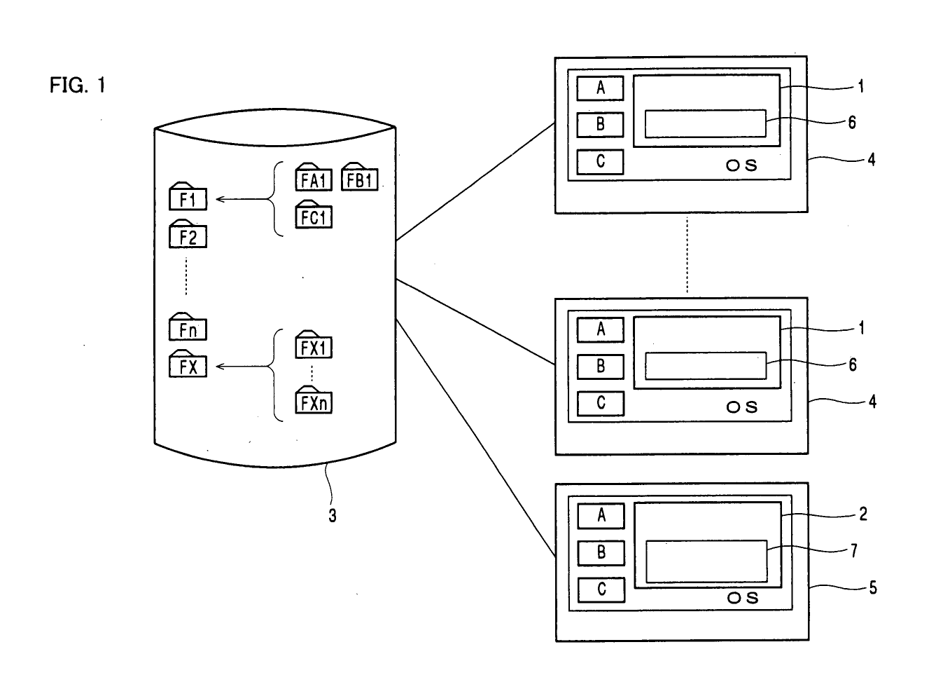

The groupware according to the present embodiment consists of a user tool 1 and an administrator tool 2. When the groupware according to this embodiment is applied to a school LAN as shown in FIG. 1 consisting of a server 3 connected to a plurality of client computers 4 and 5, the user tool 1 is installed on the client computer 4 used by students while the administrator tool 2 is installed on the client computer 5 used by the instructor. In addition, the user tool 1 also contains user viewer software 6 while the administrator tool 2 contains administrator viewer software 7.

As shown in FIG. 1, a plurality of applications A, B and C are installed on the client computers 4 and 5. The applications A, B and C installed on the client computers 4 and 5 have parameters AR0, BR0 and CR0, respectively, which specify the default destination when specifying the saving of a file. Registry information is typically used as the parameter used to identify the default destination folder for saving.

Moreover, a stipulated operating system (OS) is also installed on each of the client computers 4 and 5, so the user tool 1, administrator tool 2 and applications A, B and C run upon this OS.

In addition, as shown in FIG. 1, user folders F1 to Fn corresponding to the students registered in this groupware (User-1 to User-n) are provided upon the server 3, and within these folders F1 to Fn lo are provided subfolders FAi, FBi and FCi (i=1 to n) for storing files for applications A, B and C. Moreover, a parameter folder FX is provided upon the server 3 and within the parameter folder FX are provided individual user parameter folders FX1 to FXn corresponding to each registered student. These individual user parameter folders FX1 to FXn contain parameters ARi, BRi and CRi (i=1 to n) for applications A, B and C consisting of registry information.

Here, the parameters ARi, BRi and CRi (i=1 to n) consisting of registry information contain information that indicates at least the location of the respective corresponding subfolders FAi, FBi and FCi (i=1 to n).

Note that the registration of users (students) with the groupware is performed using the administrator tool 2 installed on client computer 5. When the administrator tool 2 is used to register a new student, the administrator tool 2 issues a username (ID) to the student, creates a user folder for that student on the server 3 and also creates a folder for individual user parameters corresponding to that student within the parameter folder FX.

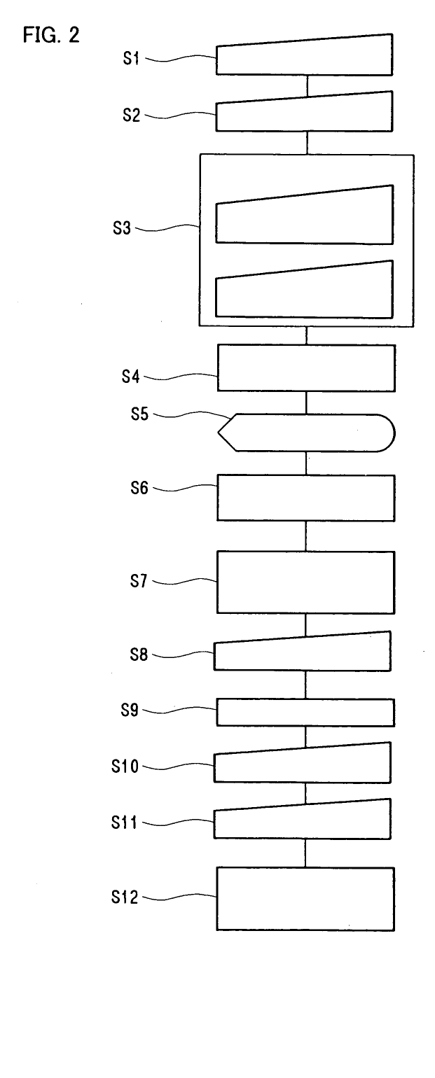

Here follows a description of the operation of user tool 1 of the groupware according to this embodiment with reference to the flowchart shown in FIG. 2.

First, when a certain registered student (taken here to be User-1) wants to use these applications A, B and C, User-1 first starts up the OS of one of the client computers 4 (Step S1). In this case, depending on the type of OS, it may be set up such that the user is requested to enter a password on startup and the startup is completed only on the condition that the correct password was entered, but when using the groupware according to this embodiment, as described in detail below, the users (students) are requested to log in when using the groupware, so it is preferable that the OS be set up so that it does not request a password to be entered upon startup.

When the OS is started up, the display of this client computer 4 displays an icon for the groupware according to this embodiment, and when this is selected and clicked using a mouse or other pointing device, the groupware according to this embodiment is started up (Step S2). However, the groupware according to this embodiment may also be set so that it is started up automatically when the OS is started up in Step S1 above.

When the groupware according to this embodiment is started up, the display of the client computer 4 displays a login screen for the groupware according to this embodiment. The login screen prompts the user to enter a username (ID) and password.

In response, User-1 uses a keyboard or the like to correctly enter his/her own username (ID) and password, thereby completing the login to the groupware according to this embodiment (Step S3). In this case, considering that the users may be young of age, it is preferable that the input of the username (ID) is completed by clicking an icon. For example, the login screen may be configured such that icons for classes of various school years are displayed upon the screen and when one of the classes is clicked, icons showing the various students in that class are displayed upon the display, and clicking on an icon indicating himself/herself will complete the input of the username (ID).

When the login is complete, the user tool 1 installed on this client computer 4 makes a request to the server 3 to send the parameters AR1, BR1 and CR1 assigned to User-1 who has logged in. The parameters AR1, BR1 and CR1 assigned to User-1 are stored in individual user parameter folder FX1 within parameter folder FX. In response, the server 3 sends AR1, BR1 and CR1 stored within individual user parameter folder FX1 to this client computer 4 and upon getting these parameters AR1, BR1 and CR1 (Step S4), client computer 4 displays a menu screen upon its display (Step S5).

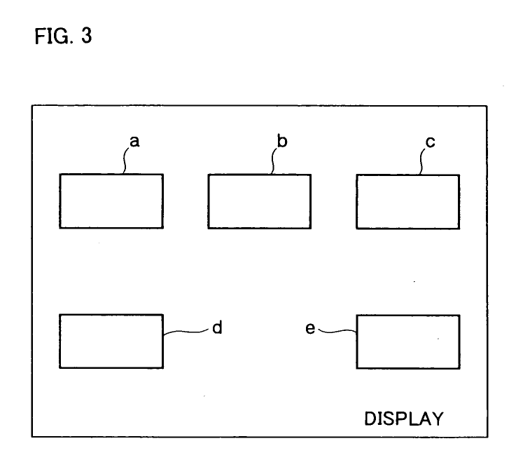

FIG. 3 is one example of a menu screen. As shown in FIG. 3, the menu screen displays at least buttons a to c for starting up applications A, B and C, button d for opening a user folder and button e for logging off

During this period, among the parameters set for each of the respective applications A, B and C, the user tool 1 installed on client computer 4 reads the parameters AR0, BR0 and CR0 which indicate the folders specified as the default destinations for saving files and temporarily stores them (Step S6). Next, user tool 1 overwrites parameters AR0, BR0 and CR0 with the parameters AR1, BR1 and CR1 gotten in Step S4, respectively (Step S7). Thereby, the environment is set so that when a file save is specified in applications A, B and C, the defaults specified in subfolders FA1, FB1 and FC1 within user folder F1 are specified as the save destination.

In this state, when the logged in User-1 uses a mouse or other pointing device to click button a and select application A (Step S8), application A is started up (Step S9). Thereby, User-1 is able to use application A. To save a file created using application A, it is necessary to 5 specify “Save File” with respect to application A, and in this case, the default destination for saving the file is set as subfolder FA1 within user folder F1 as described above.

Similarly, when User-1 uses a mouse or other pointing device to click buttons b or c, applications B or C are started up and when “Save File” is specified with respect to applications B or C, the default destination for saving the file is set as subfolder FB1 or FC1 within user folder F1.

Thereby, when saving a file created using applications A, B or C, User-1 needs only specify “Save File” with respect to these applications and select confirm (enter) to save the files in subfolders FA1, FB1 or FC1 on the server 3, so there is no need to perform the operation of changing the destination to save the file.

In addition, when User-1 uses a mouse or other pointing device to click button d, the user viewer software 6 contained in user tool 1 is started up. In this case, based on the username (ID) used at login, the user viewer software 6 displays the contents of the corresponding user subfolder F1. Thereby, User-1 can easily view a list of his/her own files. In this case, the user viewer software 6 cannot open the other user folders F2 to Fn so files created by other students cannot be viewed.

Thereafter, when User-1 shuts down the applications A, B and C that had been started up (Step S10) and then clicks button e, user tool 1 removes the menu screen from the display (Step S11) and reads the parameters AR0, BR0 and CR0 that were temporarily stored in Step S6, and again overwrites the parameters AR1, BR1 and CR1 that were overwritten in Step S7 (Step S12). Thereby, the parameters of the applications A, B and C on this client computer 4 are returned to the state prior to login.

In this manner, with the groupware according to this embodiment, when a student who has logged in attempts to save a file created using applications A, B or C, the subfolders FA1, FB1 and FC1, respectively, within the user folder are specified as the default, so there is no need to perform the operation of changing the destination for saving the file. Thus, the burden of operation upon the user is lessened and also the scattering of files is effectively prevented.

Here follows a description of the operation of administrator tool 2 of the groupware according to this embodiment.

The administrator tool 2 has the function for registering new users (students) described above and also has a function for viewing the contents of the subfolders F1 to Fn stored on the server 3. To wit, when the administrator tool 2 is started up and the administrator viewer software 7 contained therein is started up, the administrator viewer software 7 displays the contents of subfolders F1 to Fn on the display of the client computer 5. Thereby, the instructor serving as the administrator can easily obtain a list of the students' files and also view their content.

In this case, the administrator viewer software 7 cannot display the content of any folder other than user folders F1 to Fn and their subfolders. This is because the files to be viewed are saved within the server 3 in a state already organized by the user tool 1 described above according to the student that created them and the application used, so there is no need to view any folders other than user folders F1 to Fn and their subfolders. Thus, the instructor serving as the administrator can use the administrator viewer software 7 to easily view these files.

As described above, with the groupware according to this embodiment the burden of operation upon the user is lessened and the viewing of files by the administrator is simplified.

Note that the above description of the embodiment describes the case of a login by User-1, but the same applies to the case a login by User-2 to User-n, and the above operation is performed depending on the username (ID) used at login.

Here follows a description of a preferred embodiment of the present invention.

This embodiment differs from the above embodiment in that the parameters that change depending on the user (student) that has logged in are kept not as registry information but rather in an initialization file. An initialization file is typically a file that contains various settings for each application, and its content is automatically updated when the user modifies the operating environment of the application. Examples of elements of the operating environment determined based on the initialization file include the types of fonts selected automatically when creating a new document or paper settings.

Accordingly, in this embodiment, the individual user parameter folders FX1 to FXn within the server 3 contain not the parameters ARi, BRi and CRi (i=1 to n) as registry information, but rather the parameters Ali, BIi and Cli (i=1 to n) in an initialization file. On the other hand, the initialization files on each client computer 4 corresponding to applications A, B and C contain content that reflects its immediately previous state of usage. Here, “AIx,” “BIx” and “CIx” are assumed to be the current initialization files for applications A, B and C on each client computer 4.

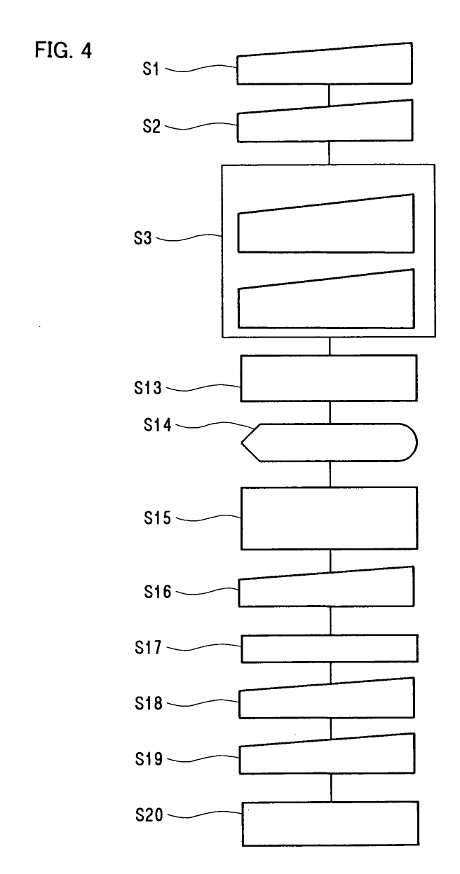

Here follows a description of the operation of user tool 1 of the groupware according to this embodiment with reference to the flowchart shown in FIG. 4. However, the OS startup (Step S1), groupware startup (Step S2) and groupware login (Step S3) are the same as in the embodiment above, so a description thereof is omitted. Note that we will proceed with the description of this embodiment again assuming that the student that logs in is “User-1.”

When the login is complete, the user tool 1 installed on this client computer 4 makes a request to the server 3 to send the parameters AI1, BI1 and CI1 assigned to User-1 who has logged in. The parameters AR1, BR1 and CR1 assigned to User-1 are stored in individual user parameter folder FX1 within parameter folder FX. In response, the server 3 sends AM1, BI1 and CI1 stored within individual user parameter folder FX1 to this client computer 4 and upon getting these parameters AI1, BI1 and CI1 (Step S13), client computer 4 displays a menu screen upon its display (Step S14). In this embodiment also, as shown in FIG. 3, the menu screen displays at least buttons a to c for starting up applications A, B and C, button d for opening a user folder and button e for logging off.

During this period, user tool 1 overwrites parameters AIx, BIx and CIx with the parameters AI1, BI1 and CI1 gotten in Step S13, respectively (Step S15). Thereby, the operating environments for applications A, B and C are based on the content of the respective parameters AI1, BI1 and CI1.

In this state, when the logged in User-1 uses a mouse or other pointing device to click button a (Step S16), application A is started up (Step S17). Thereby, User-1 is able to use application A. In this case, as described above, application A has the operating environment based on parameter AI1 so User-1 can use application A in an operating environment customized to him/her rather than the operating environment based on the immediately previous state of usage.

Here, if User-1 changes the settings of application A, the content of parameter AI1 is overwritten under the control of application A. For example, if the paper size selected at the time of creation of a new document is changed from A4 to B5, then the content of parameter AI1 is changed to reflect this change.

Similarly, when User-1 uses a mouse or other pointing device to click buttons b or c, applications B or C are started up based on the content of parameters BI1 or BI1. Thereby, User-1 can use applications B or C in an operating environment customized to himself/herself rather than the operating environment based on the immediately previous state of usage. In addition, if User-1 changes the settings of applications B or C, the content of parameters BI1 or CI1 is overwritten.

In addition, when User-1 uses a mouse or other pointing device to click button d, the user viewer software 6 contained in user tool 1 is started up, but this is the same as described in the above embodiment, so its description is omitted here.

Thereafter, when User-1 shuts down the applications A, B and C that had been started up (Step S18) and then clicks button e, user tool 1 removes the menu screen from the display (Step S19). User tool 1 then sends the parameters AI1, BI1 and CI1 to the server 3 and directs that they be stored in individual user parameter folder FX1 within parameter folder FX. Thereby, the content of the parameters AI1, BI1 and CI1 contained in individual user parameter folder FX1 is updated to the most recent content (Step S20).

In this manner, with the groupware according to this embodiment, each user (student) can use applications A, B and C in the same environment as when the applications A, B and C were last used by that student regardless of which of the client computers 4 is used, so the burden of operation upon the user is lessened.

Note that the above description of the embodiment describes the case of a login by User-1, but the same applies to the case a login by User-2 to User-n, and the above operation is performed depending on the username (ID) used at login.

The present invention is in no way limited to the above embodiments, but rather various modifications are possible within the scope of the invention recited in the claims, and naturally these are also contained within the scope of the invention.

For example, the former embodiment was described in the case that the parameters that are changed are parameters (AR0, BR0 and CR0) that indicate the default destination for saving a file when saving a file, but the type of parameters is not limited to these parameters, but rather they may also be parameters that indicate, for example, the default origin for loading a file when loading a file.

Industrial Usability

In this manner, the groupware according to the present invention may be applied to a school LAN consisting of a server and a plurality of clients, for example, and thus used for study and exchanging opinions among students and the like.

1. Groupware that operates upon a stipulated OS and permits usage by various users upon login, said groupware comprising: means of changing the parameters of stipulated applications associated to said groupware depending on the username at the time of login and means of returning said parameters of said stipulated applications at the time of logoff to their state prior to said login.

2. Groupware that operates upon a stipulated OS and permits usage by various users upon login, said groupware comprising: means of changing the parameters of stipulated applications associated to said groupware in response to a login with a first username and means of changing the parameters of said stipulated applications to a second content different from said first content in response to a login with a second username.

3. Groupware that operates upon a stipulated OS and permits usage by various users upon login, said groupware comprising: means of saving the parameters of stipulated applications associated to said groupware at the time of a login and means of changing the parameters of said stipulated applications depending on the username after said saving is performed.

4. Groupware that operates upon a stipulated OS and permits usage by various users upon login, said groupware comprising: means of getting from a server parameters corresponding to the username, means of replacing parameters of stipulated applications associated to said groupware with the parameters thus gotten, means of changing the content of the parameters thus replaced based on the operation of the user logging in, and means of saving said changed parameters on said server at the time of a logoff

5. Groupware according to claim 1, wherein said parameters define the folder specified as the default destination of saving when a file save is specified with respect to said stipulated applications.

6. Groupware according to claim 2, wherein said parameters define the folder specified as the default destination of saving when a file save is specified with respect to said stipulated applications.

7. Groupware according to claim 3, wherein said parameters define the folder specified as the default destination of saving when a file save is specified with respect to said stipulated applications.

8. Groupware according to claim 4, wherein said parameters define the folder specified as the default destination of saving when a file save is specified with respect to said stipulated applications.
